(19) United States
(12) Patent Application Publication
(10) Pub. No.: US 2025/0216603 A1
(43) Pub. Date: Jul. 3, 2025

(54) OPTICAL SYSTEMS WITH BEAM-SHAPING FACETS

(71) Applicant: Apple Inc., Cupertino, CA (US)

(72) Inventor: Mark A. Arbore, Los Altos, CA (US)

(21) Appl. No.: 18/988,868

(22) Filed: Dec. 19, 2024

Related U.S. Application Data
(60) Provisional application No. 63/615,116, filed on Dec. 27, 2023.

(51) Int. Cl. G02B 6/12; G02B 6/42

(52) U.S. Cl. CPC G02B 6/12004; G02B 6/12014; G02B 6/4204

(57) ABSTRACT

Embodiments are directed to photonic integrated circuits, as well as optical systems incorporating these photonic integrated circuits, that include emitters having asymmetric, aspheric on-chip lenses. These on-chip lenses may each generate an emission light beam that has a different intensity profile, along a slow axis of the emission light beam, relative to an input light beam that is used to generate the emission light beam. This may allow for individual tailoring of the intensity profiles of different emission light beams, which may simplify the design of optical systems that incorporate these emitters.

### CROSS-REFERENCE TO RELATED APPLICATIONS

This application is a nonprovisional and claims the benefit under 35 U.S.C. 119 (e) of U.S. Provisional Patent Application No. 63/615,116, filed Dec. 27, 2023, the contents of which are incorporated herein by reference as if fully disclosed herein.

### FIELD

This disclosure relates generally to optical systems that use a set of on-chip lenses to output light from a photonic integrated circuit. More particularly, embodiments herein relate to photonic integrated circuits with on-chip lenses having asymmetrically curved facets.

### BACKGROUND

Photonic integrated circuits are increasingly used in optical systems to generate and emit light. A photonic integrated circuit may include one or more integrated light sources that are controllable to generate light, and the photonic integrated circuit may route, modify, and/or otherwise manipulate this light before launching the light from the photonic integrated circuit. An optical system may include additional optical components, such as one or more lenses, to further modify the light after it is emitted from the photonic integrated circuit. Accordingly, an optical system may emit light for one or more purposes, such as performing a spectroscopic measurement. Depending on the optical system, it may be desirable for the light to have certain properties as it exits the optical system. It may be difficult, however, to route light within an optical system while still maintaining a relatively small form factor.

### SUMMARY

Embodiments described herein directed to photonic integrated circuits that include emitters having on-chip lenses. Some embodiments are directed to a photonic integrated circuit having a waveguide layer, where the waveguide layer includes a slab waveguide having a side surface and a waveguide. The side surface defines an on-chip lens having an asymmetric and aspherical curved shape, and the waveguide is positioned such that an input light beam introduced from the waveguide into the slab waveguide exits the slab waveguide through the on-chip lens to generate an emission light beam.

In some variations, the waveguide is tilted relative to a center ray of the emission light beam at a tilt angle. In some of these variations, the tilt angle is at least nine degrees. In some of these variations, the tilt angle is at least twelve degrees. Additionally or alternatively, the on-chip lens includes an intermediate portion positioned between a first peripheral portion and a second peripheral portion, wherein the intermediate portion has a larger radius of curvature than the first and second peripheral portions. In some of these variations, a center ray of the input light beam passes through the intermediate portion. Additionally or alternatively, the waveguide is positioned such that portions of the input light beam that are backreflected off of the intermediate portion do not couple into the waveguide.

Other embodiments are directed to an optical system that includes a light source unit and a photonic integrated circuit. The photonic integrated circuit includes a side surface and a plurality of emitters optically connected to the light source unit. Each emitter includes an on-chip lens formed from a portion the side surface, the on-chip lens having an asymmetric, aspheric curve, a slab waveguide, and a waveguide. The waveguide is positioned such that an input light beam introduced from the waveguide into the slab waveguide exits the slab waveguide through the on-chip lens to generate an emission light beam. The optical system further includes a controller configured to control the plurality of emitters to emit the emission light beams. The emission light beam may at least partially overlap to form a composite light beam.

In some variations, the optical system includes a slow axis collimating lens positioned to at least partially collimate the composite light beam. Additionally or alternatively, the optical system may include a diffuser positioned to diffuse the composite light beam. In some variations, at least some of the emission light beams are emitted along different directions. Additionally or alternatively, the waveguide of each emitter is tilted relative to a center ray of the corresponding emission light beam at a corresponding tilt angle, and the tilt angles of at least some of the emitters are different. Additionally or alternatively, the on-chip lenses of at least some of the plurality of emitters have different shapes. In some variations, the on-chip lens of each emitter includes a corresponding intermediate portion positioned between a corresponding first peripheral portion and a corresponding second peripheral portion, wherein the corresponding intermediate portion has a larger radius of curvature than the corresponding first and second peripheral portions.

Still other embodiments are directed to a photonic integrated circuit having a waveguide layer, where the waveguide layer includes a slab waveguide having a side surface and a waveguide. The side surface defines an on-chip lens having an intermediate portion positioned between a first peripheral portion and a second peripheral portion, wherein the intermediate portion has a larger radius of curvature than the first and second peripheral portions. Additionally, the waveguide is positioned such that an input light beam introduced from the waveguide into the slab waveguide exits the slab waveguide through the on-chip lens to generate an emission light beam.

In some variations, a center ray of the input light beam passes through the intermediate portion. Additionally or alternatively, the waveguide is tilted relative to a center ray of the emission light beam at a tilt angle. In some of these variations, the tilt angle is at least nine degrees. In some of these variations, the tilt angle is at least twelve degrees. In some variations, the side surface defines an additional on-chip lens and an additional waveguide, such that the photonic integrated circuit may emit an additional emission light beam.

In addition to the example aspects and embodiments described herein, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a schematic diagram of a variation of a photonic integrated circuit as described herein.

FIG. 2 shows a perspective view of a portion of a photonic integrated circuit that includes an emitter.

FIGS. 3A and 3B show top views of photonic integrated circuits that include emitters, where the emitters include an on-chip lens having a hemispherical shape.

FIG. 4 shows a top view of a portion of an optical system that includes a photonic integrated circuit that with multiple emitters.

FIGS. 5A-5C depict top views of a variation of a photonic integrated circuit that includes an emitter, where the emitter includes an on-chip lens having an asymmetric shape such as described herein.

FIG. 6 shows a top view of a variation of a photonic integrated circuit that includes multiple emitters, where each emitter includes a corresponding on-chip lens having an asymmetric shape.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

It should be understood that the proportions and dimensions (either relative or absolute) of the various features and elements (and collections and groupings thereof) and the boundaries, separations, and positional relationships presented between them, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following description is not intended to limit the disclosure to any preferred embodiment. To the contrary, it is intended to cover alternatives, modifications, and equivalents as can be included within the spirit and scope of the described embodiments as defined by the appended claims.

Described herein are photonic integrated circuits, as well as optical systems incorporating these photonic integrated circuits, that include emitters having asymmetric, aspheric on-chip lenses. These on-chip lenses may each generate an emission light beam that has a different intensity profile, along a slow axis of the emission light beam, relative to an input light beam that is used to generate the emission light beam. This may allow for individual tailoring of the intensity profiles of different emission light beams, which may simplify the design of optical systems that incorporate these emitters.

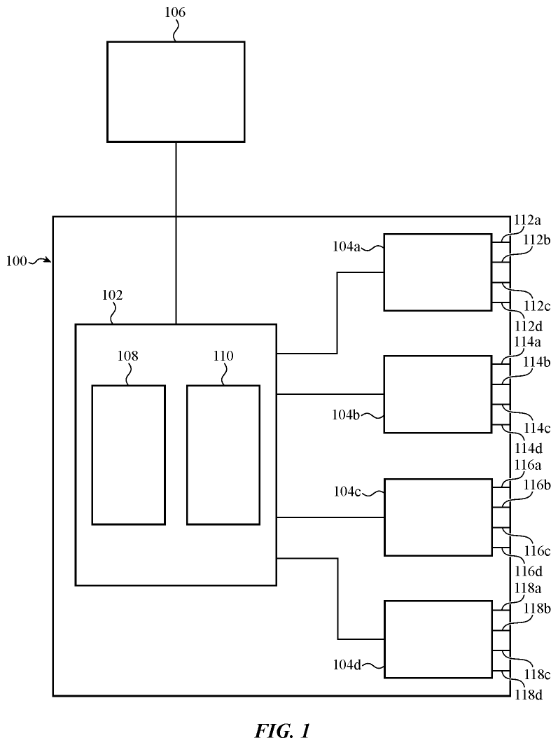

FIG. 1 shows a schematic diagram of a photonic integrated circuit 100 that may be used with the optical systems described herein. The photonic integrated circuit 100 includes a light generation assembly 102 and a set of launch groups 104a-104d, each of which may be used to emit light from the photonic integrated circuit 100. The light generation assembly 102 is configured to generate light and route the light to the set of launch groups 104a-104d, thereby allowing some or all of the launch groups 104a-104d to emit light. While the photonic integrated circuit 100 is shown in FIG. 1 as having four launch groups 104a-104d, it should be appreciated that the photonic integrated circuit 100 may include a single launch group or a plurality of launch groups having any suitable number of launch groups as may be desired.

The light generation assembly 102 may include a light source unit 108 having a set of light sources (not shown) each of which is selectively operable to emit light at a corresponding set of wavelengths. The set of light sources may be controlled to generate light, and this light may be routed from the light generation assembly 102 to the set of launch groups 104a-104d. Each light source may be any component capable of generating light at one or more particular wavelengths, such as a light-emitting diode or a laser. A laser may include a semiconductor laser, such as a laser diode (e.g., a distributed Bragg reflector laser, a distributed feedback laser, an external cavity laser), a quantum cascade laser, or the like. A given light source may be single-frequency (fixed wavelength) or may be tunable to selectively generate one of multiple wavelengths (e.g., the light source may be controlled to output different wavelengths at different times). The set of light sources may include any suitable combination of light sources, and collectively may be operated to generate light at any of a plurality of different wavelengths.

In some variations, the light source unit 108 includes multiple sets of light sources, where each set of light sources is associated with a different corresponding launch group of the set of launch groups 104a-104d. In these instances, each launch group may receive light generated from a different set of light sources of the light source unit 108. In other variations, multiple launch groups of the set of launch groups 104a-104d may receive light from a common set of light sources of the light source unit 108. For example, the light generation assembly 102 may include a switch network 110 that is configured to selectively route light generated by the light source unit 108 to any or all of the set of launch groups 104a-104d.

Specifically, the switch network 110 receives light from the light source unit 108 via one or more inputs, each of which is optically connected to a corresponding output of the light source unit 108 to receive light therefrom. The switch network 110 may include a plurality of outputs, each of which is connected to a corresponding launch group of the set of launch groups 104a-104d. The switch network 110 is controllable to take light received at one of its inputs and direct that light to some or all of its outputs simultaneously. For example, the switch network 110 may be configured in a first instance to route light from the light source unit 108 to a single launch group (e.g., a first launch group 104a), or may simultaneously route the light to multiple launch groups (e.g., all four launch groups 104a-104d). In these instances, the light source unit may include relatively fewer light sources, as a single set of light sources may be used to provide light to multiple launch groups. The switch network 110 may include any optical components (e.g., a series of controllable optical switches) as may be needed to selectively route light between the light source unit 108 and the set of launch groups 104a-104d.

Each launch group of the set of launch groups 104a-104d includes at least one emitter that may emit a corresponding light beam from the photonic integrated circuit 100. To emit light from a given emitter, that emitter may be optically coupled to the light generation assembly 102 to receive light therefrom and may emit this light as a light beam. In some instances, the individual light beams emitted by the different emitters of a given launch group may at least partially overlap and thereby collectively form a composite light beam. For example, in the variation shown in FIG. 1, a first launch group 104a includes a first set of emitters 112a-112d, each of which may emit a corresponding light beam. Similarly, a second launch group 104b includes a second set of emitters 114a-114d, a third launch group 104c includes a third set of emitters 116a-116d, and a fourth launch group 104d includes a fourth set of emitters 118a-118d. While each of the set of launch groups 104a-104d is shown in FIG. 1 as having the same number of emitters (e.g., four emitters for each launch group), it should be appreciated that different launch groups may have different corresponding numbers of emitters.

Also shown in FIG. 1 is a controller 106, which controls operation of the photonic integrated circuit 100 to generate and emit light. Specifically, the controller 106 may control the light generation assembly 102 to generate and route light to one or more of the set of launch groups 104a-104d. For example, in instances where the light generation assembly 102 includes the light source unit 108 and the switch network 110, the controller 106 may control one or more light sources of the light source unit 108 to generate a selected wavelength (or wavelengths) of light. The controller 106 may further control the switch network 110 to route light received from the light source unit 108 to a selected number of the launch groups 104a-104d. Accordingly, the controller 106 may control the various emitters to emit light. The controller 106 may include any combination of software, hardware, and firmware as needed to perform these functions (including any of the method steps described below), including, for example, one or more processors and/or application-specific integrated circuits (ASICs).

The photonic integrated circuit 100 may utilize waveguides to optically connect the components on the photonic integrated circuit 100. For example, in the embodiment shown in FIG. 1, each launch group of the set of launch groups 104a-104d may be optically coupled to the light generation assembly 102 via a corresponding waveguide. Similarly, each emitter of a given launch group may include a corresponding waveguide that receives light from the light generation assembly 102. For example, in instances where a given launch group includes multiple emitters, the launch group may include one or more optical splitters, such that the launch group may receive light from a single waveguide and may split that light across multiple waveguides (e.g., with a corresponding waveguide associated with each emitter).

The waveguides of a photonic integrated circuit 100 are typically supported on a planar substrate and confine light to travel along a horizontal plane of the photonic integrated circuit. Specifically, the photonic integrated circuit may include a waveguide layer that is configured to carry light within the photonic integrated circuit. In order to launch light from a photonic integrated circuit (e.g., at the emitters associated with the set of launch groups 104a-104d), light may either be redirected from the horizontal plane (e.g., through a top or bottom surface of the photonic integrated circuit) using a vertical output coupler or may exit horizontally along a lateral side surface of the photonic integrated circuit. When light is emitted horizontally from a lateral side surface of a photonic integrated circuit, light may be carried by a waveguide and may be directed to pass through a facet of the photonic integrated circuit (e.g., an interface between the waveguide layer and an external material, such as air or an optical component placed in contact with the photonic integrated circuit).

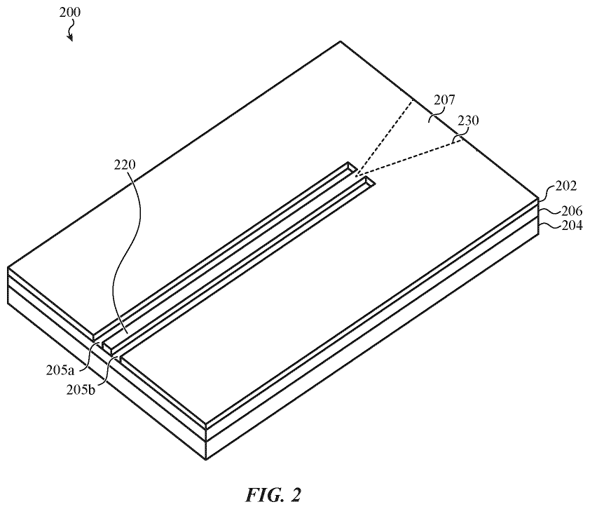

As light passes through the facet, some of the light may undesirably reflect from the side of the photonic integrated circuit back into the waveguide. For example, FIG. 2 shows a perspective view of a portion of a photonic integrated circuit 200. Specifically, the photonic integrated circuit 200 may include a planar waveguide layer 202 that is supported by a substrate 204. In some instances a cladding layer 206 is positioned between the substrate 204 and the waveguide layer 202, such that the substrate 204 supports the cladding layer 206, and the cladding layer 206 supports the waveguide layer 202. The cladding layer 206 may help to confine light within a plane of the waveguide layer 202, and the photonic integrated circuit 200 may include additional cladding layers positioned in contact with other surfaces of the waveguide layer 202. The various layers of the photonic integrated circuits described herein may be formed from any suitable materials depending on the wavelength or wavelengths of light that will be carried by the waveguides defined in the photonic integrated circuit. For example, in some variations, the waveguide layer (including any waveguides defined in and formed by the waveguide layer) is formed from silicon, silicon nitride, silica, or the like, the cladding layer (or layers) is formed from a dielectric material (or materials) such as silicon dioxide, and the substrate is formed from silicon.

The waveguide layer 202 may be processed to define a waveguide 220 and a slab waveguide 207, such that the waveguide 220 terminates at an interface with the slab waveguide 207. Specifically, the waveguide layer 202 may be etched or patterned to define a pair of cavities 205a-205b in the waveguide layer 202. These cavities may define the waveguide 220 (e.g., a first cavity 205a defines a first lateral surface of the waveguide 220 and the second cavity 205b defines a second lateral surface of the waveguide 220) and may help to confine light within the waveguide 220. In some variations, the photonic integrated circuit includes an additional cladding layer or layers that fill the cavities 205a-205b. In some of these instances, an additional cladding layer or layers may also cover a top side of the waveguide 220, such that the waveguide is surrounded by cladding layers. In other instances, the cavities 205a-205b may be left unfilled to provide an air interface to the lateral side surfaces of the waveguide 220. In some of these instances, the top surface of a waveguide may also be uncovered to provide an air interface with the top surface of the waveguide 220.

Accordingly, when light is introduced into the waveguide 220, the light may be confined within the waveguide 220 due to a refractive index difference between the waveguide 220 and its surrounding materials (e.g., the cladding layer(s) and/or air in contact with the waveguide 220). The cavities 205a-205b terminate at the interface between the waveguide 220 and the slab waveguide 207. Because the cavities 205a-205b are no longer acting to confine light in the waveguide 220, and light passing from the waveguide 220 into the slab waveguide 207 may diffract and freely propagate within the slab waveguide 207. In this way, the slab waveguide 207 acts a free propagation region. It should be appreciated that while light may freely propagate laterally within the plane of the waveguide layer 220 as it travels through the slab waveguide 207, the light may still be confined vertically such that it is confined within the plane of the waveguide layer 220.

When light exits the waveguide 220 at an interface with a free propagation region (e.g., the slab waveguide), the light may diffract at the interface to generate a light beam 230 (also referred to herein as an “input light beam”) within the slab waveguide 207. The input light beam 230 will expand horizontally within the slab waveguide 207 at a rate that depends on the diffraction angle, and will propagate until it reaches a facet of the photonic integrated circuit 200. For example, a vertical side surface of the slab waveguide 207 (which thereby defines a vertical side surface of the waveguide layer 202) may form a facet through which light may exit the photonic integrated circuit 200 via the slab waveguide 207. As light exits the photonic integrated circuit 200 via the facet. When light passes through the interface between the waveguide layer 202 and another material (e.g., air surrounding the photonic integrated circuit, another optical component placed in contact with the photonic integrated circuit), at least a portion of the input light beam 230 will reflect off of this interface. Light that is incident on the facet at normal incidence (such as when a portion of the facet is perpendicular to the waveguide 220) may be at least partially reflected back toward and couple into the waveguide. This back-reflected light may create etalons and negatively impact the stability of light sources used to generate illumination in the photonic integrated circuit. Accordingly, it may be desirable to configure a facet for a given emitter to minimize back-reflections into waveguide associated with that emitter.

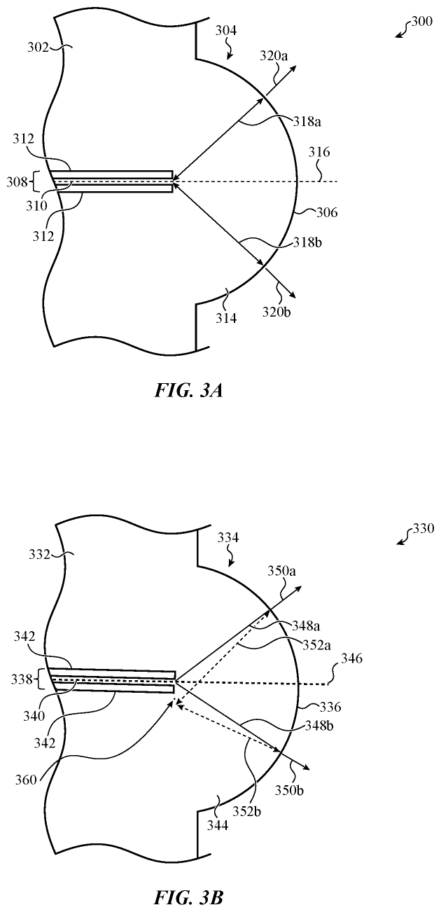

In some variations, the photonic integrated circuits described herein may be configured such that one or more facets of the photonic integrated circuit are shaped to define an on-chip lens. Specifically, a vertical side surface of a slab waveguide may be shaped to define a curve. The shape of the curve may act to modify an input light beam (e.g., input light beam 230) as it exits the slab waveguide, and thereby exits the photonic integrated circuit. For example, on-chip lenses formed from a vertical side surface of a slab waveguide are described in in U.S. Patent Publication No. US2023/0089758A1, titled “Light Output Devices and Light Outputting Methods for Optical Systems”, the contents of which are hereby incorporated by reference in their entirety. FIG. 3A shows a top view one such variation of a photonic integrated circuit 300. While only a waveguide layer 302 of the photonic integrated circuit 300 is shown in FIG. 3A, the photonic integrated circuit 300 may also include a substrate, a lower cladding layer, and optionally an upper cladding layer as discussed previously.

The photonic integrated circuit 300 includes a side surface 304 that serves as a facet through which light may be emitted from the photonic integrated circuit 300. The side surface 304 defines an optical element 306 that forms a cylindrical on-chip lens having a semi-circular curve. The photonic integrated circuit further includes a waveguide 308 and a slab waveguide 314 defined in the waveguide layer 302. Specifically, the waveguide 308 includes a waveguide core 310 bounded and defined by a pair of light confining regions 312. The waveguide 308 terminates into the slab waveguide 314 to define a junction between the waveguide 308 and the slab waveguide 314. Collectively, the waveguide 308, the slab waveguide 314, and the on-chip lens form an emitter of the photonic integrated circuit 300, and may act as an emitter of one of the launch groups 104a-104d of the photonic integrated circuit 100 of FIG. 1.

When an input light beam is introduced into the slab waveguide 314 from the waveguide 308, this input light beam (the boundaries of which are represented by arrows 318a and 318b) will diverge horizontally within the slab waveguide 314. In FIG. 3A, the waveguide 308 is positioned such that the junction between the waveguide 308 and the slab waveguide 314 is positioned at the center of curvature (not shown) of the optical element 306. In this way, the input light beam is centered along a line 316, as shown in FIG. 3A, that intersects the center of curvature of the optical element 306. In these instances, the input light beam will not change its divergence as light exits the photonic integrated circuit 300 through the optical element 306. Specifically, when the input light beam is introduced into the slab waveguide 314 from the waveguide 308, each ray within the input light beam will hit the optical element 306 at normal incidence (assuming that the optical element 306 is sized such that the input light beam reaches its far field before hitting the optical element 306). As each ray hits the optical element 306 at normal incidence, each ray continues along the same direction as it undergoes the refractive index change between the slab waveguide 314 and the material (e.g., air) in contact with the side surface 304. Accordingly, the optical element 306 will emit a light beam (also referred to herein as an “emission light beam”, which is represented by its outermost rays 320a and 320b) with the same beam divergence as the input light beam.

When a ray of light hits the optical element 306 at normal incidence, back reflections caused as light exits slab waveguide 314 will be retroreflected back to the waveguide 308. In effect, the back-reflected light (the boundaries of which are also represented by arrows 318a and 318b) is focused by the optical element 306 at the entrance of the waveguide 308. To mitigate this, a waveguide may be positioned such that it is laterally offset with respect to the center of curvature of the semi-circular curve. FIG. 3B shows another variation of a photonic integrated circuit 330 that includes a waveguide 338 that is laterally offset relative to an optical element 336 that forms an on-chip lens. As with the photonic integrated circuit 300 of FIG. 3A, the photonic integrated circuit 330 may be part of the optical systems described herein, and may include a substrate, a lower cladding layer, a waveguide layer 332 and optionally an upper cladding layer (though only waveguide layer 332 is depicted in FIG. 3B).

The photonic integrated circuit 330 includes a side surface 334 that serves as an output facet through which light may be emitted from the photonic integrated circuit 330. The side surface 334 defines an optical element 336 that forms a cylindrical on-chip lens having a semi-circular curve. The photonic integrated circuit further includes a waveguide 338 and a slab waveguide 344 defined in the waveguide layer 332. Specifically, the waveguide 338 includes a waveguide core 340 bounded and defined by a pair of light confining regions 342. The waveguide 338 terminates into the slab waveguide 344 to define a junction between the waveguide 338 and the slab waveguide 344.

Unlike the waveguide 308 of FIG. 3A, the waveguide 338 of photonic integrated circuit 330 is positioned such that the junction between the waveguide 338 and the slab waveguide 344 is not positioned at a center of curvature 360 of the optical element 336. In the variation shown in FIG. 3B, the waveguide 338 is laterally offset relative to the center of curvature 360 of the optical element 336. Specifically, the waveguide 338 is positioned such that waveguide 338 introduces a beam of input light beam (the outer bounds of which are represented by rays 348a, 348b) into the slab waveguide 344 such that the beam is centered along a line 346 that does not intersect the center of curvature 360 of the optical element 336.

When the waveguide 338 is laterally offset relative to the center of curvature 360, various rays of the input light beam will hit the optical element 336 at non-perpendicular angles. As a result, the back reflections caused as these rays exit the slab waveguide 344 are not retroreflected back to the waveguide 338. Instead, the back reflections (the outer bounds of which are represented in FIG. 3B by rays 352a, 352b) are effectively focused to a different point in the slab waveguide 344. If the waveguide 338 is sufficiently laterally offset relative to the center of curvature 360 of the optical element 336 (and assuming no aberrations or imperfections are introduced during manufacturing), none of the back reflections from the side surface 334 should directly couple into the waveguide 338.

When an on-chip lens for a given emitter defines a semi-circular curve as depicted in FIGS. 3A and 3B, the on-chip lens may not significantly alter the intensity profile of an input light beam as it exits the photonic integrated circuit. Specifically, the input light beam may have a Gaussian beam profile in which the intensity of the input light beam has a peak intensity at a center of the input light beam, and decreases from the peak intensity according to a Gaussian distribution. In this way, the input light beam will be significantly more intense near its center as compared to its edges, as will the emission light beam that exits the emitter.

In some instances, however, it may be desirable for an emission light beam to have a different beam profile within an optical system. For example, it may be desirable for a given emission light beam to have uniform intensity across the emission light beam (or a central portion of the emission light beam). When the emission light beam is used to illuminate a particular region (e.g., a component within an optical system, a sample measured by an optical system, or the like), it may be desirable for that region to receive uniform illumination. Accordingly, it may be desirable to at least partially flatten the intensity profile of an emission light beam within an optical system.

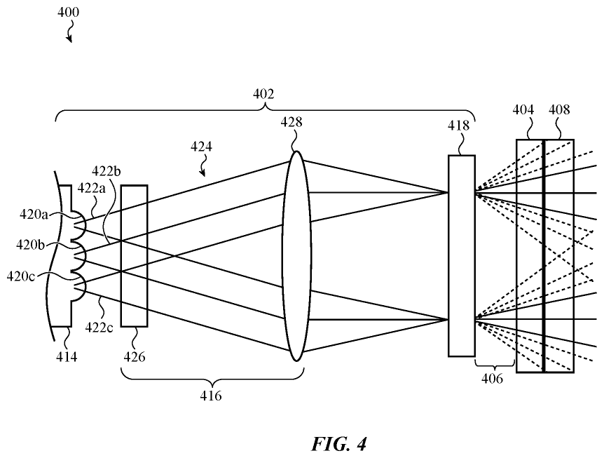

While the intensity profile of an emission light beam may be altered by other components (e.g., a lens) within the optical system, there may be drawbacks to using these components to alter the intensity profile. For example, FIG. 4 depicts a top view of a variation of an optical system 400 that includes a beam generator 402 that is configured to generate an output light beam 406 using a plurality of individual emission light beams. Specifically, the beam generator 402 includes a photonic integrated circuit 414 that includes plurality of emitters 420a-420c. These emitters 420a-420c may correspond to some or all of the emitters of a launch group of the photonic integrated circuit 414 (such as the launch groups 104a-104d of the photonic integrated circuit 100 of FIG. 1), such that the emitters 420a-420c may simultaneously receive light generated by a light generation assembly as described herein. As shown in FIG. 4, each of the plurality of emitters 420a-420c may include an on-chip lens through which a corresponding emission light beam is emitted from the photonic integrated circuit 414. Accordingly, the plurality of emitters 420a-420c may emit a corresponding plurality of individual emission light beams 422a-422c.

The plurality of emission light beams 422a-422c may at least partially overlap, such that the plurality of emission light beams 422a-422c collectively form a composite light beam 424. In this way, multiple emitters may be used to generate a composite light beam that is larger in one or more dimensions than an individual emission light beam. For example, any number of emitters 420a-420c (e.g., two, three, four, five, ten, twenty, or thirty or more emitters) may be positioned along a given direction to achieve a particular beam width for the composite light beam 424 in that direction.

The composite light beam 424 may be modified using one or more additional components in order to generate the output light beam 406. For example, in the optical system of FIG. 4, the beam generator 402 also includes an optical unit 416 that comprises a set of lenses and a diffuser 418. The optical unit 416 may be configured to modify the divergence of the composite light beam 424 in one or more dimensions, and the diffuser 418 may diffuse the composite light beam 424 to generate the output light beam 406. Each of the plurality of emission light beams 422a-422c may, upon exiting the photonic integrated circuit 414, diverge differently in different dimensions. For example, the plurality of individual light beams 422a-422c may, upon exiting the photonic integrated circuit 414, may diverge both along a first dimension perpendicular to the plane of the waveguide layer (e.g., waveguide layer 202 of the photonic integrated circuit 200 of FIG. 2), referred to herein as the “fast axis”, and along a second dimension that is parallel to the plane of the waveguide layer, referred to herein as the “slow axis.” Each emission light beam may, as it exits the photonic integrated circuit 414, have a higher divergence along the fast axis than its divergence along the slow axis.

In some variations, the optical unit 416 may be configured to at least partially collimate the input light beam 424 along the fast and slow axes. For example, in the variation shown in FIG. 4, the optical unit 416 includes a fast axis collimating lens 426 that is configured to at least partially collimate each of the plurality of emission light beams 422a-422b (and thereby at least partially collimate the composite light beam 424) along the fast axis. The optical unit further includes a slow axis collimating lens 428 that is configured to at least partially collimate each of the plurality of emission light beams 422a-422b (and thereby at least partially collimate the composite light beam 424) along the slow axis.

Additionally, the slow axis collimating lens 428 may be positioned relative to the photonic integrated circuit 414 such that the individual emission light beams 422a-422c intersect at the diffuser 418. In these instances, the size of the composite light beam 424 along the slow axis as it enters the diffuser 418 may be independent of the number of emitters 420a-420c and the corresponding number of emission light beams 422a-422c. Additionally, to the extent that different emitters of the plurality of emitters 420a-420c emit emission light beams 422a-422c having different phases (e.g., in variations where one or more phase shifters are used to alter the relative phases of these emission light beams 422a-422c), the size of the composite light beam 424 along the fast axis as it enters the diffuser 418 will be independent of the relative phases of the individual light beams 422a-422c.

Once the composite light beam 424 has passed through the diffuser 418 to generate the output light beam 406, the optical system 400 may optionally be configured to further modify the output light beam 406 and/or to emit the output light beam 406 from the optical system 400. For example, the optical system 400 may include an optical assembly 404 that is positioned to receive and shape the light beam 406. The optical assembly 404 may include one or more lenses or prisms that are positioned and configured to further shape and/or redirect the light beam 406 within the optical system. Additionally or alternatively, the optical system 400 may include a system interface 408 through which the light beam 406 may pass to exit the optical system 400. For example, the optical system 400 may be part of an optical measurement system, and the light beam 406 may be used to generate light as part of measurement (e.g., a spectroscopic measurement).

In the optical system 400 of FIG. 4, if the intensity profiles of the input light beams are not altered, the individual emission light beams 422a-422c may each have a Gaussian intensity profile along the slow axis as it reaches the diffuser 418. In these instances, the intensity of the output beam along the slow axis will be significantly higher at a center of the output light beam 406 as compared to the edges of the output light beam 406. In many instances, however, it may be desirable for the output beam to have a more uniform intensity profile, both along the fast and slow axes. In some instances, the fast axis collimating lens 426 may be designed to at least partially flatten the beam intensity along the fast axis and the slow axis collimating lens 428 may at least partially flatten the beam intensity along the slow axis. Because each of the individual emission light beams 422a-422c is incident on the slow axis collimating lens 428 at a combination of position and angle, it may be difficult to design a slow axis collimating lens 428 that is able to provide the desired intensity changes for each emission light beam. This difficulty increases with the number of emitters 420a-420c and corresponding emission light beams 422a-422c. Accordingly, depending on the requirements of the optical system 400, the slow axis collimating lens 428 may be unable to fully provide a desired beam intensity profile for the composite light beam 424 in the slow axis.

Conversely, the optical systems described herein include emitters with on-chip lenses where each on-chip lens is configured to change the beam intensity profile of the emission light beam along the slow axis. In this way, the beam intensity profile of each emission light beam may be tuned individually, thereby simplifying the design of other components within the optical system. For example, when the emitters described herein are incorporated into the optical system 400 of FIG. 4 (e.g., to replace the emitters 420a-420c), the individual emission light beams 422a-422c may have intensity profiles that are at least partially flattened in the slow axis, as compared to the input light beams used to generate them, before they reach the slow axis collimating lens 428. This may significantly simplify the design of the slow axis collimating lens.

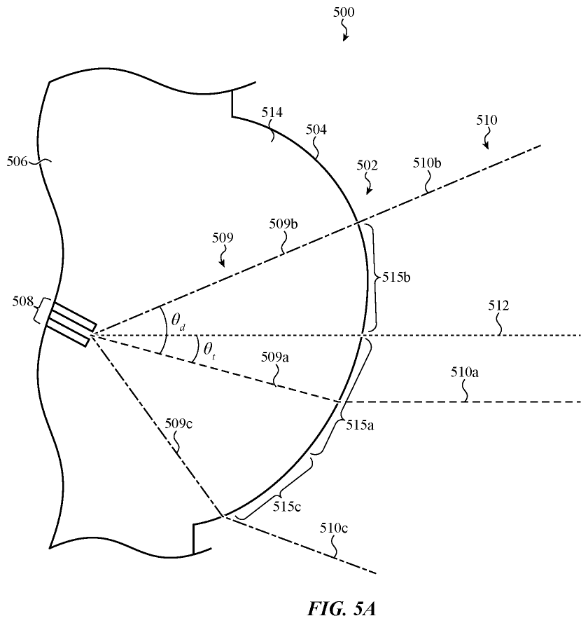

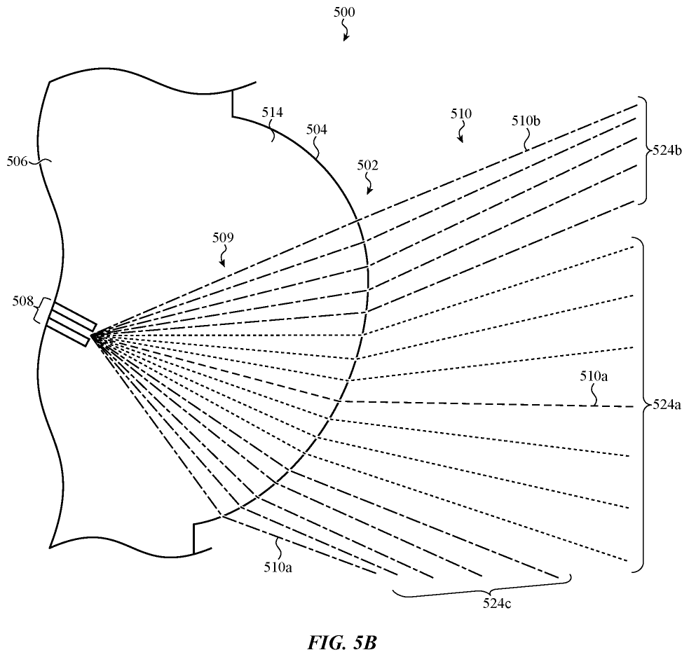

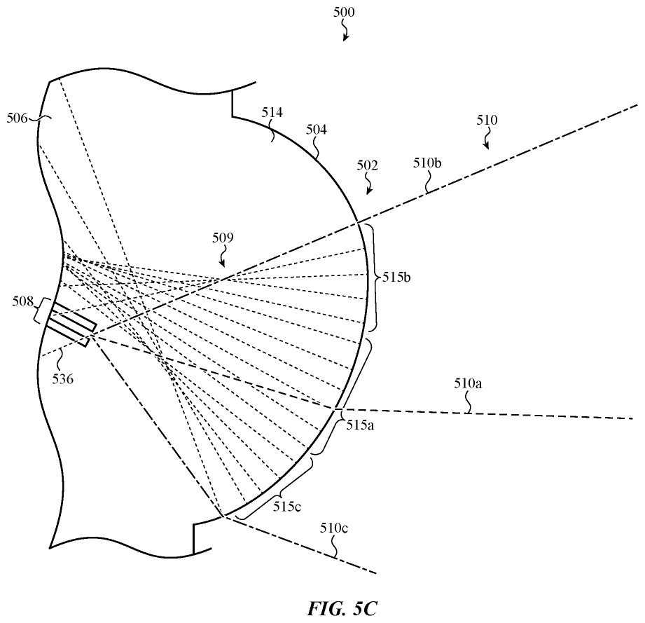

In some variations, to at least partially flatten the intensity profile of an emission launch beam, an on-chip lens of an emitter may be shaped to include a curve that is both asymmetric and aspheric. For example, FIGS. 5A-5C show a variation of a photonic integrated circuit 500 that includes an emitter 502. A side surface of the photonic integrated circuit is shaped to define an on-chip lens 504. While only a waveguide layer 506 of the photonic integrated circuit 500 is shown in FIGS. 5A-5C, the photonic integrated circuit 500 may also include a substrate, a lower cladding layer, and optionally an upper cladding layer as discussed previously.

The emitter 502 further includes a waveguide 508 and a slab waveguide 514 defined in the waveguide layer 506, such as described in more detail with respect to FIGS. 2-3B. The waveguide 508 terminates into the slab waveguide 514 to define a junction between the waveguide 508 and the slab waveguide 514. Light may be introduced into the emitter 502 via the waveguide 508, such that an input light beam 509 is generated within the slab waveguide 514. The input light beam 509 may exit the photonic integrated circuit 500 through the on-chip lens 504 to generate an emission light beam 510. The input light beam 509 is represented in FIG. 5A by a center ray 509a and outermost rays 509b and 509c (each of which has corresponding divergence angle θ_{d} relative to the center ray 509a). Similarly, the output light beam 510 is represented in FIG. 5A by a center ray 510a and an outermost rays 510b and 510c.

For the purpose of discussion, the outermost rays 509b and 509c of the input light beam 509, as well as the outermost rays 510b and 510c of the emission light beam 510 are considered to have a respective threshold minimum intensity that is less than the 1/e² value (e.g., the intensity falls to 1/e² times the peak intensity corresponding to the center ray) for the corresponding light beam. For example, in the variation shown in FIGS. 5A-5C, the input light beam 509 has a Gaussian intensity profile in the slow axis (e.g., in the plane of the waveguide layer 506), and thus 1/e² value for the input light beam 509 corresponds to about ±30 degrees relative to the center ray 509a. In other words, the individual rays within ±30 degrees of the center ray 509a will have an intensity that is at least 1/e² times the intensity of the center ray 509a.

Accordingly, the on-chip lens may be configured to at least partially flatten the intensity profile, in the slow axis, of at least the portion of the input light beam 509 corresponding to the 1/e² value (e.g., the portion of the input light beam 509 corresponding to ±30 degrees relative to the center ray). In some variations, the on-chip lens may be configured to at least partially flatten the intensity profile, in the slow axis, of additional portions of the input light beam 509 having intensity less than the 1/e² value. For example, in the variation shown in FIGS. 5A-5C, the outermost rays 509b and 509c of the input light beam 509 correspond to ±40 degrees relative to the center ray 509a. In these instances, the on-chip lens 504 may at least partially flatten the intensity profile for at least the rays that are ±40 degrees relative to the center ray 509a. Rays outside of this range (which have a significantly smaller intensity as compared to center ray 509a) may be handled differently by the on-chip lens 504 depending on the needs of an optical system (e.g., optical system 400) incorporating the photonic integrated circuit 500. In other variations, the on-chip lens 504 may at least partially flatten the intensity profile for at least the rays that are ±50 degrees relative to the center ray 509a or that are ±60 degrees relative to the center ray 509a, if so desired.

Due to the asymmetric, aspherical curve of the on-chip lens 504, the curvature of the on-chip lens 504 will vary across the facet defined by the on-chip lens 504. For example, as shown in FIG. 5A, the on-chip lens 504 includes an intermediate portion 515a, a first peripheral portion 515b, a second peripheral portion 515c. The intermediate portion 515a is positioned between the first and second peripheral portions 515b, 515c, and the radius of curvature of the on-chip lens 504 is larger in the intermediate portion 515a than in the first and second peripheral portions 515b, 515c. It should be appreciated that the radius of curvature of the one-chip lens 504 may vary within each of these portions, and in these instances the entire range of values of the radius of curvature in the intermediate portion 515a may be larger than the entire ranges of values of the radius curvature in the first and second peripheral portions 515b, 515c.

In these instances, the intermediate portion 515a will be less curved than the first and second peripheral portions 515b, 515c, which may act to change the relative intensity of portions of the emission light beam 510 relative to the input light beam 509. For example, FIG. 5B shows the photonic integrated circuit 500 of FIG. 5A, but illustrates additional rays of the input and emission light beams 509, 510. Specifically, a first set of rays 524a correspond to the portion of the input light beam 509 (and the portion of the emission light beam 510) that passes through the intermediate portion 515a of the on-chip lens 504. The first set of rays 524a includes the center rays of the input and emission light beams 509, 510, such that the center ray 509a of the input light beam 509 passes through the intermediate portion 515a. Similarly, a second set of rays 524b correspond to the portion of the input and emission light beams 509, 510 that passes through the first peripheral portion 515b, and a third set of rays 524c correspond to the portion of the input and emission light beams 509, 510 that passes through the second peripheral portion 515c.

Because the radius of curvature of the on-chip lens 504 is smaller in the first and second peripheral portions 515b, 515c, the first and second peripheral portions 515b, 515c will have a stronger focusing effect than the intermediate portion 515a. As a result, the peripheral portions of the input light beam 509 (e.g., the second and third sets of rays 524b, 524c) will be focused to a relatively smaller area as compared to the central portion of the input light beam 509 (e.g., the first et of rays 524a), which will increase the relative intensity of the peripheral portions of output light beam 510 as compared to the central portion of the output light beam 510. Since the average intensity is smaller in the peripheral portions of the input light beam 509 than in the central portion of the input light beam 509, the stronger focusing provided by the first and second peripheral portions 515b, 515c may act to increase the uniformity of the input light beam 509 along the slow axis.

When a on-chip lens 504 has an asymmetric, aspheric curve, it may be more difficult to position the waveguide 508 such that no back reflected rays will couple into the waveguide 508. To address this, the on-chip lens 504 and waveguide 508 may be positioned such that the waveguide 508 is angled relative to the center ray 510a of the output light beam 510. For example, as shown in FIG. 5A, the waveguide 508 may be aligned along a first direction corresponding to the direction of the center ray 509a of the input light beam 509. The on-chip lens 504 is configured to redirect the center ray 509a along a different direction (e.g., parallel to line 512 in FIG. 5A), such that the center ray 510a of the emission light beam 510 travels in a different direction. Specifically, the center ray 510a of the emission light beam 510 may be tilted relative to the center ray 509a at a tilt angle θₜ. Accordingly, the waveguide 508 is also titled relative to the center ray 510a of the emission light beam 510 by the tilt angle θₜ.

In some variations, the tilt angle ↓ₜ is selected such that no rays corresponding to the 1/e² value (e.g., no rays having an intensity greater than 1/e² times the maximum intensity) of the input light beam 509 are retroreflected into the waveguide 508. It should be appreciated that although the emitter 502 is designed to prevent this retroreflection, in practice it may be possible for some light corresponding to the 1/e² value may inadvertently be retroflected into the waveguide 508 due to imperfections or other aberrations introduced as part of the manufacturing of the photonic integrated circuit 500. For example, FIG. 5C shows reflected rays 536 that are back-reflected as the input light beam 509 exits the on-chip lens 504. As shown there, the back-reflected rays corresponding to the intermediate portion 515a and the second peripheral portion 515b of the on-chip lens are directed away from the waveguide 508. Some back-reflected rays corresponding to the first peripheral portion 515a of the on-chip lens 504 (e.g., a back-reflected ray corresponding to the outermost ray 509b) may be retroreflected in the waveguide. Because these retroreflected rays are outside of the 1/e² range of the input light beam 509, and only a small percentage of the intensity of these rays are backreflected, the amount of light that couples back into the waveguide 508 may be sufficiently small as to not significantly impact the operation of the photonic integrated circuit 500.

In some variations, to decrease the intensity of the retroreflected light that is coupled into the waveguide 508, the waveguide 508 may be tilted at a tilt angle θₜ of at least 9 degrees. In some of these variations, the waveguide 508 may be titled at a tilt angle θₜ of at least 12 degrees. In some of these variations, the waveguide 508 may be titled at a tilt angle θₜ of at least 15 degrees.

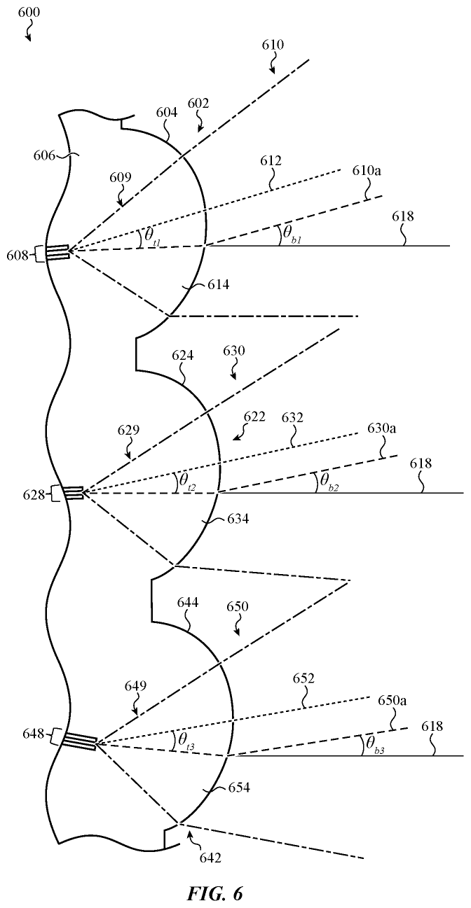

The photonic integrated circuit 500 may be incorporated into the optical system 400 of FIG. 4, such that the on-chip lens 504 at least partially flattens the intensity profile, in the slow axis, of the emission light beam 510 relative to the input light beam 509. In some variations, the photonic integrated circuit 500 may include multiple emitters having on-chip lenses with asymmetric, aspheric curves. For example, FIG. 6 shows a variation of a photonic integrated circuit 600 that includes a plurality of emitters having asymmetric, aspheric on-chip lenses. While only a waveguide layer 606 of the photonic integrated circuit 600 is shown in FIG. 6, the photonic integrated circuit 600 may also include a substrate, a lower cladding layer, and optionally an upper cladding layer as discussed previously.

Specifically, the photonic integrated circuit 600 includes a first emitter 602, a second emitter 622, and a third emitter 624, though it should be appreciated that the plurality of emitters may include any number of emitters as may be desired. Each of these emitters 602 may be configured as described above with respect to emitter 502 of FIG. 5. Specifically, the first emitter 602 includes a first waveguide 608 and a first on-chip lens 604 defined by a side surface of a first slab waveguide 614 formed in the waveguide layer 606. The first waveguide 608 may emit a first input light beam 609 into the first slab waveguide 614, and the first on-chip lens 604 may generate a first emission light beam 610. The first on-chip lens 604 may have a first aspheric, asymmetric curve, and the first waveguide 608 may be tilted at a first tilt angle θₜ₁ relative to a beam direction 612 of the first emission light beam 610.

Similarly, the second emitter 622 includes a second waveguide 628 and a second on-chip lens 624 defined by a side surface of a second slab waveguide 634 formed in the waveguide layer 606. The second waveguide 628 may emit a second input light beam 629 into the second slab waveguide 634, and the second on-chip lens 624 may generate a second emission light beam 630. The second on-chip lens 624 may have a second aspheric, asymmetric curve, and the second waveguide 628 may be tilted at a second tilt angle θₜ₂ relative to a beam direction 632 of the second emission light beam 630. The third emitter 642 includes a third waveguide 648 and a third on-chip lens 644 defined by a side surface of a third slab waveguide 654 formed in the waveguide layer 606. The third waveguide 648 may emit a third input light beam 649 into the third slab waveguide 654, and the third on-chip lens 644 may generate a third emission light beam 650. The third on-chip lens 644 may have a third aspheric, asymmetric curve, and the third waveguide 648 may be tilted at a second tilt angle θₜ₃ relative to a beam direction 652 of the third emission light beam 650.

Accordingly, the photonic integrated circuit 600 includes plurality of emitters, each of which includes a corresponding waveguide, slab waveguide (which may a corresponding portion of a common slab waveguide), and on-chip lens, where the on-chip lens has an asymmetric, aspheric curved shape. The photonic integrated circuit 600 may be operable to generate a plurality of emission light beams (e.g., the first, second, and third emission light beams 610, 630, 650). The plurality of emission light beams may at least partially overlap to form a larger composite light beam as described herein. In some variations, it may be desirable for at least some of the plurality of emission light beams to be emitted in different directions. For example, in the variation shown in FIG. 6, each of the first, second, and third emission light beams are directed at different angles relative to a common direction 618.

For example, the first emission light beam 610 is directed at a first beam angle θ_{b1} relative to the common direction (where the first beam angle θ_{b1} represents the angle between the center ray 610a of the first emission light beam 610 and the common direction 618). Similarly, the second emission light beam 630 is directed at a second beam angle θ_{b2} relative to the common direction (where the second beam angle θ_{b2} represents the angle between the center ray 630a of the second emission light beam 630 and the common direction 618), and the third emission light beam 650 is directed at a third beam angle θ_{b3} relative to the common direction (where the third beam angle θ_{b3} represents the angle between the center ray 650a of the third emission light beam 650 and the common direction 618). In the variation shown in FIG. 6, each of the first, second, and third beam angles θ_{b1}-θ_{b3} are different. For example, the first beam angle θ_{b1} is larger than the second beam angle θ_{b2}, which is in turn larger than the third beam angle θ_{b3}. When the photonic integrated circuit 600 is incorporated into the optical system 400 of FIG. 4 (e.g., to replace the photonic integrated circuit 414), this may direct the different emission light beams to different portions of the slow axis collimating lens 428, such that the plurality of emission light beams are directed to a common location of the diffuser 418.

In some instances where multiple emission light beams are directed in different directions, the corresponding waveguides may have different tilt angles. For example, in the variation shown in FIG. 6, the first tilt angle θₜ₁, the second title angle θₜ₂, and the third tilt angle θₜ₃ may all be different values. In other variations, some or all of the waveguides may have the same tilt angle. Similarly, depending on the design of the photonic integrated circuit 600, the first, second, and third on-chip lenses 604, 624, 644 may have the same shape or may have different shapes. Overall, each emitter may be individually tailored (e.g., with a corresponding tilt angle and shape of the on-chip lens) to achieve a particular beam direction and intensity profile in the slow axis. It should also be appreciated that, in some instances, the photonic integrated circuit 600 may include additional emitters that have on-chip lenses having other shapes (e.g., symmetric and/or hemispherical) if so desired.

Although the disclosed examples have been fully described with reference to the accompanying drawings, it is to be noted that various changes and modifications will become apparent to those skilled in the art. Such changes and modifications are to be understood as being included within the scope of the disclosed examples as defined by the appended claims.

What is claimed is:

1. A photonic integrated circuit, comprising:
a waveguide layer comprising:
a slab waveguide having a side surface; and
a waveguide, wherein:
the side surface defines an on-chip lens having an asymmetric and aspherical curved shape; and
the waveguide is positioned such that an input light beam introduced from the waveguide into the slab waveguide exits the slab waveguide through the on-chip lens to generate an emission light beam.

2. The photonic integrated circuit of claim 1, wherein:
the waveguide is tilted relative to a center ray of the emission light beam at a tilt angle.

3. The photonic integrated circuit of claim 2, wherein:
the tilt angle is at least nine degrees.

4. The photonic integrated circuit of claim 2, wherein:
the tilt angle is at least twelve degrees.

5. The photonic integrated circuit of claim 1, wherein:
the on-chip lens has an intermediate portion positioned between a first peripheral portion and a second peripheral portion; and
the intermediate portion has a larger radius of curvature than the first and second peripheral portions.

6. The photonic integrated circuit of claim 5, wherein a center ray of the input light beam passes through the intermediate portion.

7. The photonic integrated circuit of claim 5, wherein the waveguide is positioned such that portions of the input light beam that are backreflected off of the intermediate portion do not couple into the waveguide.

8. An optical system comprising:
a light source unit;
a photonic integrated circuit comprising:
a side surface; and
a plurality of emitters optically connected to the light source unit, each emitter comprising:
an on-chip lens formed from a portion the side surface, the on-chip lens having an asymmetric, aspheric curve;
a slab waveguide; and
a waveguide positioned such that an input light beam introduced from the waveguide into the slab waveguide exits the slab waveguide through the on-chip lens to generate an emission light beam; and
a controller configured to control the plurality of emitters to emit the emission light beams, wherein:
the emission light beams at least partially overlap to form a composite light beam.

9. The optical system of claim 8, comprising:
a slow axis collimating lens positioned to at least partially collimate the composite light beam.

10. The optical system of claim 8, comprising:
a diffuser positioned to diffuse the composite light beam.

11. The optical system of claim 8, wherein at least some of the emission light beams are emitted along different directions.

12. The optical system of claim 8, wherein:
the waveguide of each emitter is tilted relative to a center ray of the corresponding emission light beam at a corresponding tilt angle; and
the tilt angles of at least some of the emitters are different.

13. The optical system of claim 8, wherein:
the on-chip lenses of at least some of the plurality of emitters have different shapes.

14. The optical system of claim 8, wherein:
the on-chip lens of each emitter comprises a corresponding intermediate portion positioned between a corresponding first peripheral portion and a corresponding second peripheral portion; and
the corresponding intermediate portion of each emitter has a larger radius of curvature than the corresponding first and second peripheral portions of each emitter.

15. A photonic integrated circuit, comprising:
a waveguide layer comprising:
a slab waveguide having a side surface; and
a waveguide, wherein:
the side surface defines an on-chip lens comprising an intermediate portion positioned between a first peripheral portion and a second peripheral portion;
the intermediate portion has a larger radius of curvature than the first and second peripheral portions; and
the waveguide is positioned such that an input light beam introduced from the waveguide into the slab waveguide exits the slab waveguide through the on-chip lens to generate an emission light beam.

16. The photonic integrated circuit of claim 15, wherein a center ray of the input light beam passes through the intermediate portion.

17. The photonic integrated circuit of claim 15, wherein:
the waveguide is tilted relative to a center ray of the emission light beam at a tilt angle.

18. The photonic integrated circuit of claim 17, wherein:
the tilt angle is at least nine degrees.

19. The photonic integrated circuit of claim 18, wherein:
the tilt angle is at least twelve degrees.

20. The photonic integrated circuit of claim 15, wherein:
the side surface defines an additional on-chip lens and an additional waveguide.
